(19) United States
(12) Patent Application Publication
(10) Pub. No.: US 2018/0300302 A1
(43) Pub. Date: Oct. 18, 2018

(54) Real-Time Collaboration Live Ink

(71) Applicant: Microsoft Technology Licensing, LLC, Redmond, WA (US)

(72) Inventors: Brian Thomas Holley, Kirkland, WA (US); Ian Mikutel, Redmond, WA (US); ArunKumar Narayanan Kotiedath, Redmond, WA (US)

(21) Appl. No.: 15/639,456

(22) Filed: Jun. 30, 2017

Related U.S. Application Data
(60) Provisional application No. 62/485,937, filed on Apr. 15, 2017.

(51) Int. Cl. G06F 17/24; G06K 9/00; G06F 17/27

(52) U.S. Cl. CPC G06F 17/242; G06F 3/04883; G06F 17/2785; G06K 9/00416

(57) ABSTRACT

Digital ink stroke and point data can be sent and received over a dedicated channel for low latency real-time speeds. A bi-directional channel can be established for each client that joins a group session. Digital ink stroke and point data is communicated in a format with semantic event information to both a renderer for local rendering and a service for sending to other clients of the group session.

### CROSS REFERENCE TO RELATED APPLICATION

This application claims the benefit of Provisional Patent Application Ser. No. 62/485,937, filed Apr. 15, 2017.

### BACKGROUND

Content creation applications such as notebook applications, word processing applications, spreadsheet applications, and presentation applications are useful tools for generating and curating content. These and other content creation applications are increasingly including “inking” functionality that lets users input content and interact with the application (and content created therein) through using a pen or stylus (and sometimes fingers or other objects) in a manner evoking a pen on paper.

It is desirable to provide real-time collaboration within an application using digital ink (a “digital inking environment”) with multiple users at remote devices.

### BRIEF SUMMARY

Real-time collaboration live ink is described that can be implemented in content creation applications.

A computer-implemented method is provided that includes communicating with a service to initiated connection to join a group for collaborating in a content creation application. When inking input is received at a computing device executing the method, the inking input is defined by an ink structure including a semantic event. The semantic event can be start, continue, end, as well as other semantic events. The ink structure is provided both to a renderer at the computing device for display in a collaboration canvas and to the service for sharing to the group.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 illustrates an example operating environment in which various embodiments of the invention may be carried out.

FIG. 2 illustrates an example system with real-time collaboration live ink.

FIG. 3A illustrates an example process flow diagram of a method for real-time collaboration live ink for a content creation application.

FIG. 3B illustrates an example process flow diagram of a further method for real-time collaboration live ink for a content creation application.

FIG. 4 illustrates components of a computing device that may be used in certain embodiments described herein.

FIG. 5 illustrates components of a computing system that may be used to implement certain methods and services described herein.

### DETAILED DESCRIPTION

Real-time collaboration live ink is described that can be implemented in content creation applications. As used herein, real-time refers to a latency of less than half a second (or network latency plus less than half a second). Such a latency provides an appearance to a user of something being live.

Content creation applications are software applications in which users can contribute information. As used herein, content creation applications are directed to visual content where users can create text and/or image-based content in digital form. The term “content creation application” may in some cases by synonymous with “content authoring application”, “productivity application”, or “content authoring tool”. Since the described systems and techniques focus on applications and tools through which content is being authored these terms may be used interchangeably herein.

The described real-time collaboration live-ink feature is applicable for content creation applications that support “inking” or “digital ink”, which refers to the mode of user input where a stylus or pen (or even user finger on a touch screen or pad or possibly a mouse) is used to capture handwriting in its natural form.

An ink stroke refers to a set of properties and point data that a digitizer captures that represent the coordinates and properties of a “marking”. It can be the set of data that is captured in a single pen down, up, or move sequence. The set of data can include parameters such as, but not limited to, position, a beginning of the stroke, an end of the stroke, the pressure of the stroke, the tilt (e.g., of a pen) for the stroke (can also be referred to as the azimuth), the direction of the stroke, the time and timing of the stroke between discrete coordinates along the path of the stroke, and the color of the ‘ink’.

In a collaboration-enabled content creation application (and even in non-collaboration scenarios), an ink stroke can be defined using a semantic event and associated metadata, which include the properties and point data. The semantic event can be start, continue, end, cancel, deletion, move, transform, aggregate, and the like.

A digitizer generally provides a set of coordinates on a grid that can be used to convert an analog motion into discrete coordinate values. A digitizer may be laid under or over a screen or surface that can capture the movement of a finger, pen, or stylus (e.g., the handwriting or brush strokes of a user). Depending on the features of the digitizer, information such as pressure, speed of motion between points, and direction of motion can be collected.

With digital ink, a user can easily control the appearance of the inked word or inked drawing, just like in the real world, because of the data structure (and language) of the ink strokes, which involve the above referenced parameters (e.g., coordinates, pressure, etc.). By remaining in the form of ink strokes, inked words, as well as inked drawings, are in an ink modifiable format.

In contrast to an inked drawing, which would be composed of ink strokes (and their associated parameters, still images are not in a format that allows a user to modify the image. Examples of still drawings and images include clip art images, ready-made shapes (e.g., lines, basic shapes, arrows, flowcharts, etc.), and camera images. Although it can be possible to format and/or edit certain still drawings, the available editing tools and editable components (e.g., line, color, angle) may be limited.

For real-time ink collaboration, a point-by-point stream, not just a stroke, is provided. In contrast, current collaboration environments that allow a user to ink input may at the most provide an ink replay to a user one stroke at a time. This would result, for example, when drawing a “T” that a user would see the down stroke and then the cross stroke come in in two sections. By using a point-by-point stream as described herein, the ink can appear to be drawing across the screen. Furthermore, by communicating the described ink structure to a collaboration group, other users in the collaboration group receive ink-modifiable content. Because the ink strokes are provided in a renderer-understandable format, members of the collaboration group (or who have access to the collaboration session) have the ability to modify, edit and remix the ink content input by other members of the collaboration group (or who have access to the collaboration session).

The described ink structure is suitable for any ink type. Some content creation applications have more ink types than others. The ink type and effects can be included as parameters in the ink structure. For example, the ink types may include a pen with a set of colors, highlighters with various colors and opacity, pencils, and ink effects with multiple colors and patterns (e.g., galaxy and sparkle pens).

There are a number of communication protocols available for collaboration and synchronization. According to embodiments of the described real-time collaboration live ink, semantic information is communicated instead of exchanging of deltas (e.g., when the display that is shared is updated as a whole image or the delta changes of the pixels of the image).

Screen sharing usually entails an image being communicated from one machine to another that shows which pixels change. Refresh rates can look awkward because of the constant sending and receiving of images as the systems are sharing an entire new image as fast as they can in order to create an illusion of a screen share. In many screen sharing situations, all of the information is transmitted. To increase speed, just sending the differences, or pixel deltas may be sent. This is different than the semantic event structure used for the live ink. The described ink structure provides the data that can be used to compose the image as opposed to providing the image itself.

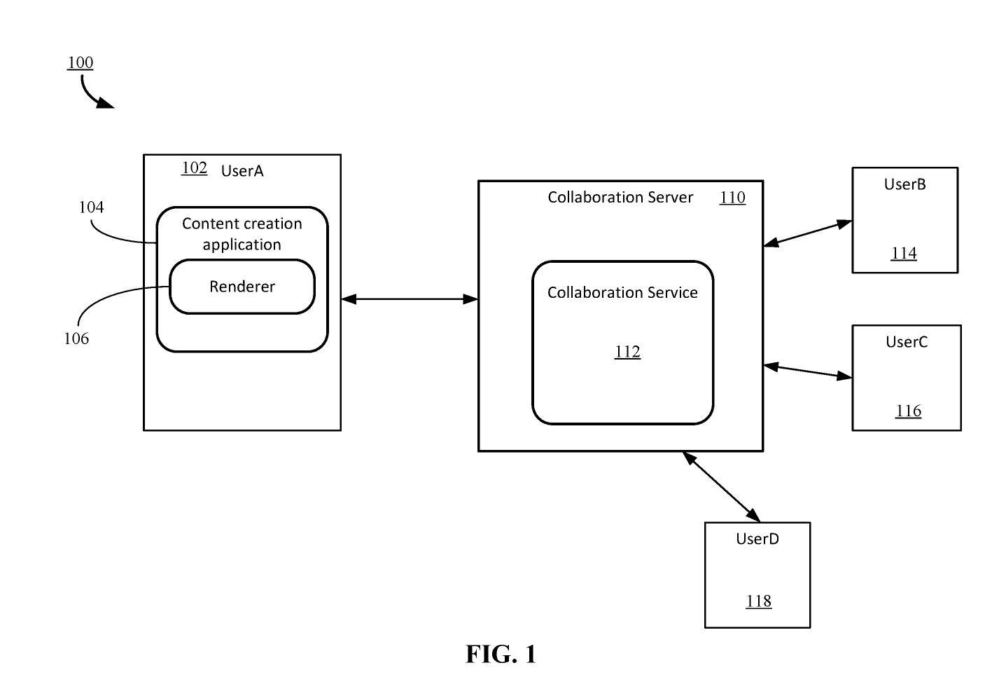

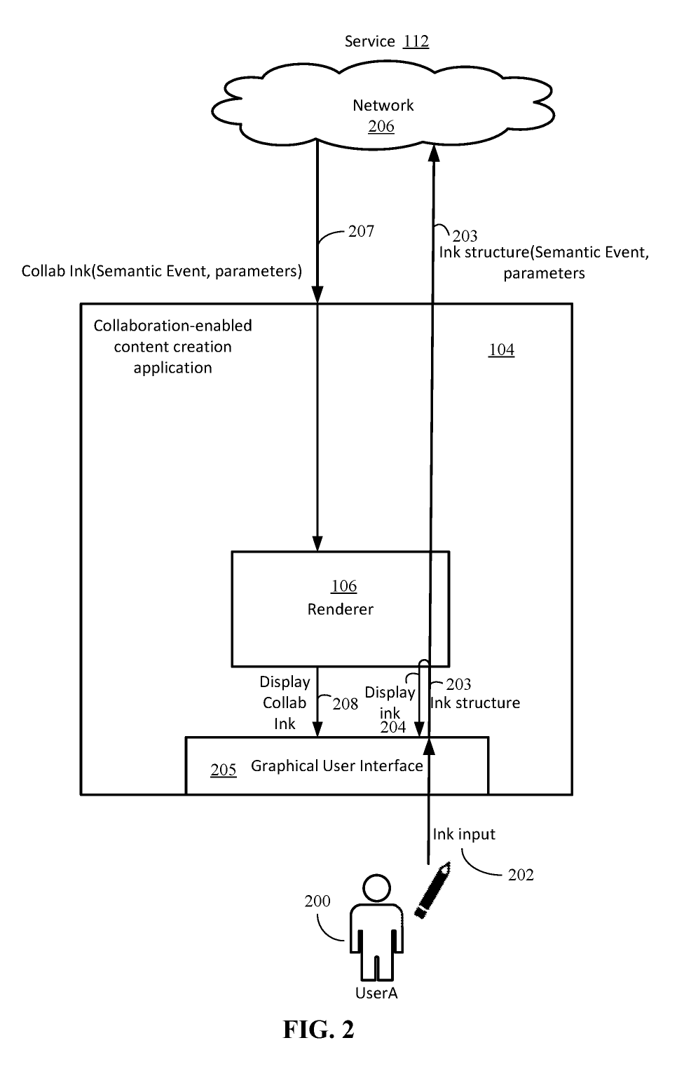

FIG. 1 illustrates an example operating environment in which various embodiments of the invention may be carried out; and FIG. 2 illustrates an example system with real-time collaboration live ink.

Referring to FIG. 1, the example operating environment 100 includes a computing device 102 for UserA running a content creation application 104 with digital inking capabilities, including a Renderer 106 that can render ink input. A collaboration server 110 running a collaboration service 112 can support collaboration functionality for the content creation application 104 and facilitate collaboration between multiple users (e.g., UserB at computing device 114, UserC at computing device 116, and UserD at computing device 118). Collaboration service 112 allows for synchronizing information between users of a collaboration session.

In addition to real-time live inking between users, certain embodiments contemplate the inclusion of autonomous agents (e.g., personal digital assistants) that can communicate via inking in a shared canvas with a particular user (e.g., autonomous agent and one user) using the same communication protocols. The autonomous agent can replay ink strokes and appear to be writing to the particular user.

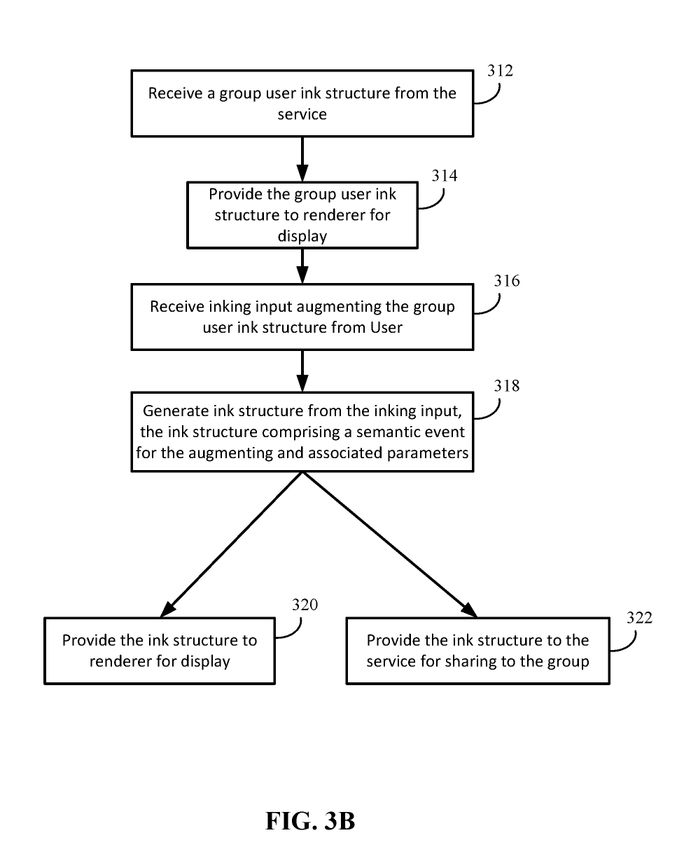

The computing device 102 (as well as computing devices 114, 116 118, or other computing devices being used to participate in a collaboration session) may be embodied as system 400 such as described with respect to FIG. 4. For example, the computing devices can each be any computing device such as, but not limited to, a laptop computer, a desktop computer, a tablet, a personal digital assistant, a smart phone, a smart television, a gaming console, wearable device, and the like.

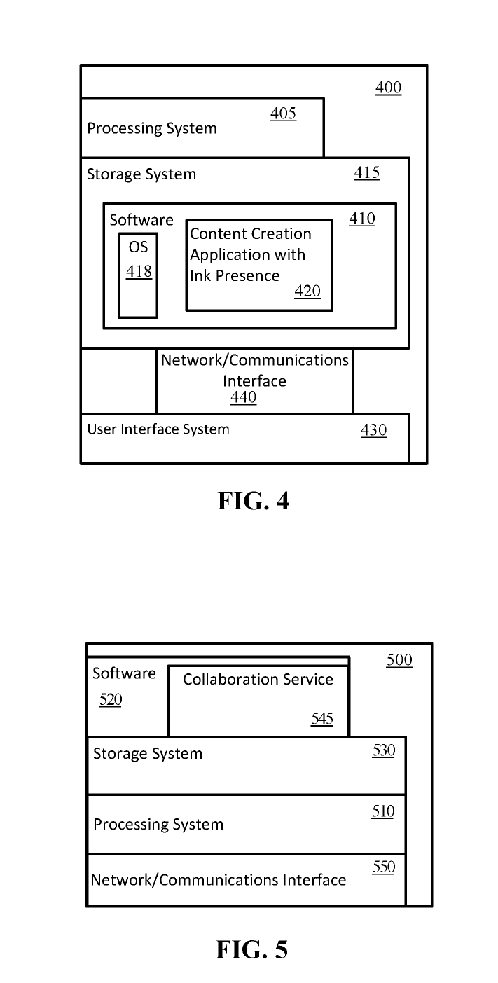

The collaboration server 110 may be embodied as system 500 such as described with respect to FIG. 5. Collaboration service 112 can perform authentication and even batching of information should the service 112 identify that one or more of the clients (e.g., at one of the computing devices) are on higher latency connections. Collaboration service 112 can also, in various implementations, support high throughput (and even peer-to-peer communications).

Referring to FIG. 2, the UserA 200 can input ink content (“ink input” 202) to the content creation application 104. Ink input 202 can be processed by a digitizer and an ink structure 203 generated.

The ink structure 203 can be a stroke event object. As mentioned above, an ink stroke refers to a set of properties and point data that a digitizer captures that represent the coordinates and properties of a “marking”. It can be the set of data that is captured in a single pen down, up, or move sequence. The set of data can include parameters such as, but not limited to, position, a beginning of the stroke, an end of the stroke, the pressure of the stroke, the tilt (e.g., of a pen) for the stroke (can also be referred to as the azimuth), the direction of the stroke, the time and timing of the stroke between discrete coordinates along the path of the stroke, and the color of the ‘ink’.

A stroke event object includes a collection of points. The stroke event object can include a stroke identifier, the action or events (referred as a “semantic event”) associated with that stroke, as a whole, and some or all of each point forming the stroke, and metadata for the stroke and/or points. In a collaboration-enabled content creation application (and even in non-collaboration scenarios), an ink stroke can be defined using semantic events and associated metadata, which include the properties and point data. The semantic event can be start, continue, end, cancel, deletion, move, transform, aggregate, and the like.

In an example implementation, a stroke event object includes semantic events of start, continue, end, and cancel. Any digitizer point information (e.g., position) associated with the event or action is included in the event object along with metadata. The metadata can include information that is needed to reconstitute and render the stroke. Examples of the metadata, also referred to herein as parameters, include size, pressure, color, format (e.g., rainbow, galaxy, sparkle), and tilt (as well as any of the other parameters previously described with respect to the structure or container of the ink stroke).

The ink structure 203 can be rendered for display (as display ink 204) at the graphical user interface 205 by the renderer 106. In a collaboration session, the content creation application 104 is collaboration-enabled and communicates with the collaboration service 112 over a network 206 to transmit the ink structure 203 and receive group ink structures 207 (which are in a same format as ink structure 203) from other users via the service 112. A received group ink structure 207 can be rendered by the renderer 106 and displayed (collab ink 208) at the graphical user interface 205.

Components (computing systems, storage resources, and the like) in the operating environment may operate on or in communication with each other over network 206. The network can be, but is not limited to, a cellular network (e.g., wireless phone), a point-to-point dial up connection, a satellite network, the Internet, a local area network (LAN), a wide area network (WAN), a Wi-Fi network, an ad hoc network or a combination thereof. Such networks are widely used to connect various types of network elements, such as hubs, bridges, routers, switches, servers, and gateways. The network 206 may include one or more connected networks (e.g., a multi-network environment) including public networks, such as the Internet, and/or private networks such as a secure enterprise private network. Access to the network 206 may be provided via one or more wired or wireless access networks as will be understood by those skilled in the art.

Communication to and from the components (e.g., the application 104 and the service 112) may be carried out, in some cases, via application programming interfaces (APIs). An API is an interface implemented by a program code component or hardware component (hereinafter “API-implementing component”) that allows a different program code component or hardware component (hereinafter “API-calling component”) to access and use one or more functions, methods, procedures, data structures, classes, and/or other services provided by the API-implementing component. An API can define one or more parameters that are passed between the API-calling component and the API-implementing component. The API is generally a set of programming instructions and standards for enabling two or more applications to communicate with each other and is commonly implemented over the Internet as a set of Hypertext Transfer Protocol (HTTP) request messages and a specified format or structure for response messages according to a REST (Representational state transfer) or SOAP (Simple Object Access Protocol) architecture. For the collaboration service, the communication is bi-directional, and therefore can be implemented using HTTP/2, WebSocket, and other bi-directional protocols.

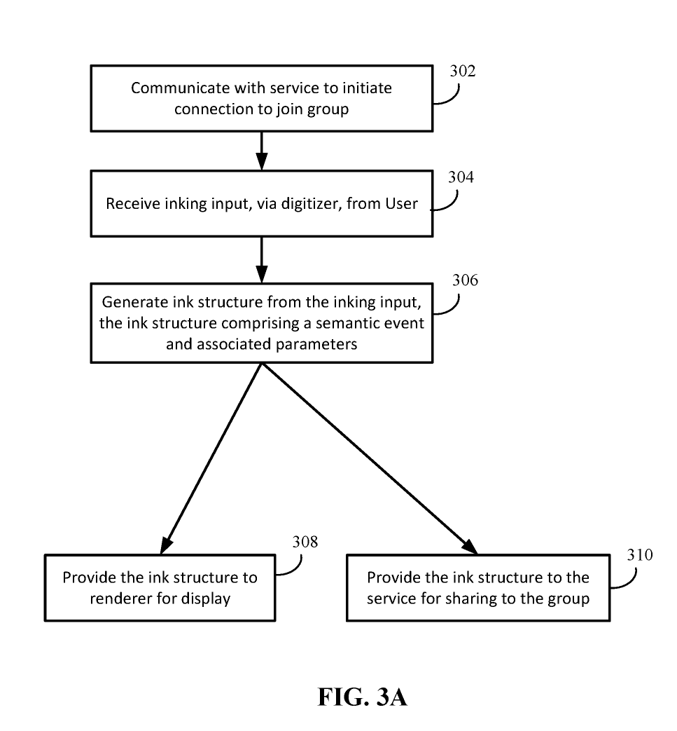

FIG. 3A illustrates an example process flow diagram of a method for real-time collaboration live ink for a content creation application; and FIG. 3B illustrates an example process flow diagram of a further method for real-time collaboration live ink for a content creation application.

Referring to FIG. 3A, a client content creation application, such as a whiteboard application, can communicate with a service to initiate (302) a connection to join a group. A bi-directional channel (e.g., via WebSocket, HTTP/2 and the like) can be set up by the connection. At a minimum, a group join communication and a group send communication are available by the collaboration service. In an example implementation, when a client connects to server supporting the collaboration service, the client can request to join a group. In some cases, the request to join a group may be initiated, for example, via a link in an email or other message. The link may direct the client to a shared content space. In some cases, the link can include an identifier of a particular group. In one example implementation, a link for joining a group can direct a user to begin a whiteboard meeting. In some cases, the request to join a group may be initiated via a command in the content creation application. For example, a user may be on the Microsoft Surface Hub or other large form factor device and select a share button for the whiteboard application.

In some cases, an authentication step may be carried out during the join operation by the service, for example, by checking the connection identifier of the client to a named group. Unauthenticated sessions are possible. For example, a group of users can agree to have an identifier for the session. In some cases, when authentication is used (e.g., for compliance), the server can cache connection criteria and authentication information for the clients (and for later verification).

In some cases, the live inking can begin after at least two users (or a user and a bot) are in a shared session. Once a user is in the shared session, the same ID that was used for getting people/instances of a content creation application user into the session can be used for the live ink channeling. That is, a group ID can be used to indicate that inking data is associated with the particular shared canvas, or collaboration space.

The client can receive (304) inking input from a user; and can generate (306) an ink structure from the inking input. The ink structure includes the appropriate semantic event for the ink input. The same ink structure can be sent (308, 310) to both the renderer for display at the client and to the service for communicating to the other members of the group. The providing of the ink structure to both the renderer and the service may be performed simultaneously.

When the user starts inking, the client sends requests to the server. The first request includes a stroke “start” as the semantic event. The ink data structure metadata (e.g., parameters) can include the stroke ID and one or more of a position, color, a pressure, a format, tilt, etc. for the ink point. As the user draws the stroke, subsequent requests include a stroke “continue” as the semantic event. The parameters that are sent with the continue semantic event may be fewer than those with the start semantic event because the format and color (and some of the other metadata) are likely the same as the start of the stroke and therefore not necessary to communicate. When the user completes the stroke, the subsequent request includes a stroke “end” as the semantic event. In some of such cases, no additional parameters are needed to be included (other than possibly position). Although start, continue, and end are described, more or fewer events may be associated with a single stroke. For a single stroke received via operation 304, the client can communicate multiple requests to the service, each request including an ink structure. For example, a first request can include a first ink structure having start as the semantic event and a second, or subsequent, request can include a second ink structure having continue or end as the semantic event.

In a specific implementation, the stroke continue event structure includes the ID and the pressure points. When the user lifts the pen, the event can be an end event (and the metadata can be simply the stroke ID). As previously mentioned, other events can include cancel, delete, move, rename, transform, and aggregate. In many cases, any action with respect to ink could have a semantic event defined for it.

The service receives the request, which can contain a stroke event object, and can validate the user permissions, for example, by identifying the clients connected to the group. The service can send the events down to the clients.

It is possible to batch up events and do compression for high latency connections. Because of the user's computing environment, it is possible to change the way the information is transmitted into batches. Transmission could also be adjusted based on how the user writes. A slow writer may cause more ink points in the strokes of data and the data may become a very large file. The more data in the file, the more likely it may be useful to compress the data for ease of transmission. The client could adjust the tempo of transmittal/requests based on how much information is received or, alternatively, the server could adjust the tempo of download to the other clients. The service could do batching if, for example, the service noticed that some clients were on higher latency connections.

In any case, the service receives the events and sends them down to other clients who would apply the semantic events to their renderer the same way they would do from their own screen.

For example, referring to FIG. 3B, a client can receive (312) a group user ink structure from the service (e.g., collab ink 207 of FIG. 2). This group user ink structure can include ink points from any of the other members of the group. Alternatively or in addition, the group user ink structure may include points from a bot. Strokes should stay in order. That is, while there can be simultaneous strokes from multiple users, the strokes from a same user should remain in proper order. The strokes from different users may be interleaved. The renderer knows that it received the ink and ID; or the renderer could just receive ink without ID and render all received ink strokes.

The received group user ink structure is provided (314) to the renderer for display at the client. The user at the client can augment the ink strokes of the other users. For example, the client can receive (316) inking input that augments the group user ink structure. The client can generate (318) an augmented ink structure from the inking input. The augmented ink structure is an ink structure with the appropriate semantic event and this augmented ink structure can be communicated (320, 322), as with other ink input, to both the renderer for display at the client and to the service for communicating with the other members of the group.

In a further implementation, for example, for a Microsoft Whiteboard application, after an ink structure is sent to the other clients, the originating client can “dry” the ink, which can involve grouping the ink strokes into a word or other logical grouping and storing the grouping, for example, in a graph structure. The “dry” ink can then be synced to the other users by sending the grouped structure to the service to the other members of the group.

FIG. 4 illustrates components of a computing device that may be used in certain embodiments described herein. Referring to FIG. 4, system 400 may represent a computing device such as, but not limited to, a personal computer, a reader, a mobile device, a personal digital assistant, a wearable computer, a smart phone, a tablet, a laptop computer (notebook or netbook), a gaming device or console, an entertainment device, a hybrid computer, a desktop computer, a smart television, or an electronic whiteboard or large form-factor touchscreen. Accordingly, more or fewer elements described with respect to system 400 may be incorporated to implement a particular computing device.

System 400 includes a processing system 405 of one or more processors to transform or manipulate data according to the instructions of software 410 stored on a storage system 415.

Examples of processors of the processing system 405 include general purpose central processing units, application specific processors, and logic devices, as well as any other type of processing device, combinations, or variations thereof. The processing system 405 may be, or is included in, a system-on-chip (SoC) along with one or more other components such as network connectivity components, sensors, video display components.

Software 410 may be implemented in program instructions and among other functions may, when executed by system 400 in general or processing system 405 in particular, direct system 400 or the one or more processors of processing system 405 to operate as described herein.

The software 410 can include an operating system 418 and application programs such as a content creation application 420 that includes the real-time live ink feature for real-time collaboration as described herein. Device operating systems generally control and coordinate the functions of the various components in the computing device, providing an easier way for applications to connect with lower level interfaces like the networking interface. It should be noted that the operating system may be implemented both natively on the computing device and on software virtualization layers running atop the native device operating system (OS). Virtualized OS layers, while not depicted in FIG. 4, can be thought of as additional, nested groupings within the operating system space, each containing an OS, application programs, and APIs.

Storage system 415 may comprise any computer readable storage media readable by the processing system 405 and capable of storing software 410 including the content creation application 420.

Storage system 415 may include volatile and nonvolatile memories, removable and non-removable media implemented in any method or technology for storage of information, such as computer readable instructions, data structures, program modules, or other data. Examples of storage media of storage system 415 include random access memory, read only memory, magnetic disks, optical disks, CDs, DVDs, flash memory, magnetic cassettes, magnetic tape, magnetic disk storage or other magnetic storage devices, or any other suitable storage media. In no case is the storage medium a transitory propagated signal.

Storage system 415 may be implemented as a single storage device but may also be implemented across multiple storage devices or sub-systems co-located or distributed relative to each other. Storage system 415 may include additional elements, such as a controller, capable of communicating with processing system 405.

The system can further include user interface system 430, which may include input/output (I/O) devices and components that enable communication between a user and the system 400. User interface system 430 can include input devices such as a mouse, track pad, keyboard, a touch device for receiving a touch gesture from a user, a digitizer, digitizing stylus, a motion input device for detecting non-touch gestures and other motions by a user, a microphone for detecting speech, and other types of input devices and their associated processing elements capable of receiving user input.

The user interface system 430 may also include output devices such as display screen(s), speakers, haptic devices for tactile feedback, and other types of output devices. In certain cases, the input and output devices may be combined in a single device, such as a touchscreen display which both depicts images and receives touch gesture and inking input from the user. A touchscreen (which may be associated with or form part of the display) is an input device configured to detect the presence and location of a touch. The touchscreen may be a resistive touchscreen, a capacitive touchscreen, a surface acoustic wave touchscreen, an infrared touchscreen, an optical imaging touchscreen, a dispersive signal touchscreen, an acoustic pulse recognition touchscreen, or may utilize any other touchscreen technology. In some embodiments, the touchscreen is incorporated on top of a display as a transparent layer to enable a user to use one or more touches to interact with objects or other information presented on the display.

Visual output may be depicted on the display (not shown) in myriad ways, presenting graphical user interface elements, text, images, video, notifications, virtual buttons, virtual keyboards, or any other type of information capable of being depicted in visual form.

The user interface system 430 may also include user interface software and associated software (e.g., for graphics chips and input devices) executed by the OS in support of the various user input and output devices. The associated software assists the OS in communicating user interface hardware events to application programs using defined mechanisms. The user interface system 430 including user interface software may support a graphical user interface, a natural user interface, or any other type of user interface.

Network interface 440 may include communications connections and devices that allow for communication with other computing systems over one or more communication networks (not shown). Examples of connections and devices that together allow for inter-system communication may include network interface cards, antennas, power amplifiers, RF circuitry, transceivers, and other communication circuitry. The connections and devices may communicate over communication media (such as metal, glass, air, or any other suitable communication media) to exchange communications with other computing systems or networks of systems. Transmissions to and from the communications interface are controlled by the OS, which informs applications of communications events when necessary.

FIG. 5 illustrates components of a computing system that may be used to implement certain methods and services described herein. Referring to FIG. 5, system 500 may be implemented within a single computing device or distributed across multiple computing devices or sub-systems that cooperate in executing program instructions. The system 500 can include one or more blade server devices, standalone server devices, personal computers, routers, hubs, switches, bridges, firewall devices, intrusion detection devices, mainframe computers, network-attached storage devices, and other types of computing devices. The system hardware can be configured according to any suitable computer architectures such as a Symmetric Multi-Processing (SMP) architecture or a Non-Uniform Memory Access (NUMA) architecture.

The system 500 can include a processing system 510, which may include one or more processors and/or other circuitry that retrieves and executes software 520 from storage system 530. Processing system 510 may be implemented within a single processing device but may also be distributed across multiple processing devices or sub-systems that cooperate in executing program instructions.

Storage system(s) 530 can include any computer readable storage media readable by processing system 510 and capable of storing software 520. Storage system 530 may be implemented as a single storage device but may also be implemented across multiple storage devices or sub-systems co-located or distributed relative to each other. Storage system 530 may include additional elements, such as a controller, capable of communicating with processing system 510.

Software 520, including a service 545, may be implemented in program instructions and among other functions may, when executed by system 500 in general or processing system 510 in particular, direct the system 500 or processing system 510 to operate as described herein for the communication service.

System 500 may represent any computing system on which software 520 may be staged and from where software 520 may be distributed, transported, downloaded, or otherwise provided to yet another computing system for deployment and execution, or yet additional distribution.

In embodiments where the system 500 includes multiple computing devices, the server can include one or more communications networks that facilitate communication among the computing devices. For example, the one or more communications networks can include a local or wide area network that facilitates communication among the computing devices. One or more direct communication links can be included between the computing devices. In addition, in some cases, the computing devices can be installed at geographically distributed locations. In other cases, the multiple computing devices can be installed at a single geographic location, such as a server farm or an office.

A network/communication interface 550 may be included, providing communication connections and devices that allow for communication between system 500 and other computing systems (not shown) over a communication network or collection of networks (not shown) or the air.

Certain techniques set forth herein may be described in the general context of computer-executable instructions, such as program modules, executed by one or more hardware processors. Generally, program modules include routines, programs, objects, components, and data structures that perform particular tasks or implement particular abstract data types.

Alternatively, or in addition, the functionality, methods and processes described herein can be implemented, at least in part, by one or more hardware modules (or logic components). For example, the hardware modules can include, but are not limited to, application-specific integrated circuit (ASIC) chips, field programmable gate arrays (FPGAs), system-on-a-chip (SoC) systems, complex programmable logic devices (CPLDs) and other programmable logic devices now known or later developed. When the hardware modules are activated, the hardware modules perform the functionality, methods and processes included within the hardware modules.

Embodiments may be implemented as a computer process, a computing system, or as an article of manufacture, such as a computer program product or computer-readable medium. Certain methods and processes described herein can be embodied as software, code and/or data, which may be stored on one or more storage media. Certain embodiments of the invention contemplate the use of a machine in the form of a computer system within which a set of instructions, when executed, can cause the system to perform any one or more of the methodologies discussed above. Certain computer program products may be one or more computer-readable storage media readable by a computer system (and executable by a processing system) and encoding a computer program of instructions for executing a computer process. It should be understood that as used herein, in no case do the terms “storage media”, “computer-readable storage media” or “computer-readable storage medium” consist of transitory propagating signals.

It should be understood that the examples and implementations described herein are for illustrative purposes only and that various modifications or changes in light thereof will be suggested to persons skilled in the art and are to be included within the scope of this application unless specifically disclaimed.

What is claimed is:

1. A method comprising:
receiving inking input via a digitizer at a client device;
generating, at the client device, an ink structure from the inking input, the ink structure comprising a semantic event;
providing the ink structure to a renderer at the client device for display in a collaboration canvas of a content creation application; and
providing the ink structure to a collaboration service for sharing to a group associated with the collaboration canvas.

2. The method of claim 1, wherein the ink structure further comprises:
a stroke identifier and one or more of a position, a color, a pressure, a format, or a tilt for an ink point of received inking input.

3. The method of claim 1, wherein providing the ink structure to the collaboration service comprises:
communicating the ink structure in a request to the collaboration service, wherein the request to the collaboration service comprises, for a single stroke received as the inking input:
a first request to the collaboration service providing a first ink structure having start as the semantic event, and
a subsequent request to the collaboration service providing a second ink structure having continue or end as the semantic event.

4. The method of claim 1, wherein the semantic event comprises start, continue, end, cancel, delete, move, rename, transform, or aggregate.

5. The method of claim 1, further comprising:
receiving a group user ink structure from the collaboration service, wherein the group user ink structure comprises a corresponding semantic event;
providing the group user ink structure to the renderer at the client device for display in the collaboration canvas;
receiving a second inking input via the digitizer at the client device, the second inking input augmenting the group user ink structure;
generating an augmenting ink structure from the inking input, the augmenting ink structure comprising another semantic event;
providing the augmenting ink structure to the renderer for display in the collaboration canvas; and
providing the augmenting ink structure to the collaboration service for sharing to the group.

6. The method of claim 5, wherein the corresponding semantic event of the group user ink structure comprises start, continue, end, cancel, delete, move, rename, transform, or aggregate.

7. The method of claim 5, wherein the group user ink structure comprises inked input from a bot.

8. The method of claim 5, wherein the group user ink structure comprises inked input from any other member of the group.

9. The method of claim 1, further comprising initiating, at the client device, a connection to join the group by communicating with the collaboration service, wherein initiating, at the client device, to join the group comprises:
requesting to the collaboration service to join the group via a link.

10. The method of claim 1, further comprising initiating, at the client device, a connection to join the group by communicating with the collaboration service, wherein initiating, at the client device, to join the group comprises:
requesting to the collaboration service to join the group in response to receiving a command to join the group via a command in the content creation application.

11. A system comprising:
a user input for receiving inking input;
one or more processors;
one or more storage media;
a network interface;
a display; and
instructions for real time collaboration live ink stored on at least one of the one or more storage media, that when executed by the one or more processors, directs the one or more processors to at least:
receive inking input via a digitizer at a client device;
generate, at the client device, an ink structure from the inking input, the ink structure comprising a semantic event; and
provide the ink structure both to a renderer at the client device for display in a collaboration canvas of a content creation application and to a collaboration service for sharing to a group associated with the collaboration canvas.

12. The system of claim 11, wherein the ink structure further comprises:
a stroke identifier and one or more of a position, a color, a pressure, a format, or a tilt for an ink point of received inking input.

13. The system of claim 11, wherein providing the ink structure to the collaboration service comprises:
communicate the ink structure in a request to the collaboration service, wherein the request to the collaboration service comprises, for a single stroke received as the inking input:
a first request to the collaboration service providing a first ink structure having start as the semantic event, and
a subsequent request to the collaboration service providing a second ink structure having continue or end as the semantic event.

14. The system of claim 11, wherein the semantic event comprises start, continue, end, cancel, delete, move, rename, transform, or aggregate.

15. The system of claim 11, wherein the instructions for real time collaboration live ink further direct the one or more processors to at least:
receive a group user ink structure from the collaboration service, wherein the group user ink structure comprises a corresponding semantic event;
provide the group user ink structure to the renderer at the client device for display in the collaboration canvas;
receive a second inking input via the digitizer at the client device, the second inking input augmenting the group user ink structure;
generate an augmenting ink structure from the inking input, the augmenting ink structure comprising another semantic event; and
provide the augmenting ink structure both to the renderer at the client device for display in the collaboration canvas and to the collaboration service for sharing to the group.

16. One or more storage media having instructions for real time collaboration live ink stored thereon, that when executed by one or more processors, directs the one or more processors to at least:
initiate, at a client device, a connection to join a group by communicating with a collaboration service;
receive inking input via a digitizer at the client device;
generate, at the client device, an ink structure from the inking input, the ink structure comprising a semantic event; and
provide the ink structure both to a renderer at the client device for display in a collaboration canvas of a content creation application and to the collaboration service for sharing to the group.

17. The media of claim 16, wherein the ink structure further comprises:
a stroke identifier and one or more of a position, a color, a pressure, a format, or a tilt for an ink point of received inking input.

18. The media of claim 16, wherein providing the ink structure to the collaboration service comprises:
communicate the ink structure in a request to the collaboration service, wherein the request to the collaboration service comprises, for a single stroke received as the inking input:
a first request to the collaboration service providing a first ink structure having start as the semantic event, and
a subsequent request to the collaboration service providing a second ink structure having continue or end as the semantic event.

19. The media of claim 16, wherein the semantic event comprises start, continue, end, cancel, delete, move, rename, transform, or aggregate.

20. The media of claim 16, wherein the instructions for real time collaboration live ink further direct the one or more processors to at least:
receive a group user ink structure from the collaboration service, wherein the group user ink structure comprises a corresponding semantic event;
provide the group user ink structure to the renderer at the client device for display in the collaboration canvas;
receive a second inking input via the digitizer at the client device, the second inking input augmenting the group user ink structure;
generate an augmenting ink structure from the inking input, the augmenting ink structure comprising another semantic event; and
provide the augmenting ink structure both to the renderer at the client device for display in the collaboration canvas and to the collaboration service for sharing to the group.
